(19) United States
(12) Patent Application Publication
(10) Pub. No.: US 2009/0091273 A1
(43) Pub. Date: Apr. 9, 2009

(54) LIGHT SOURCE FOR GENERATING EXTREME ULTRAVIOLET LIGHT FROM PLASMA

(75) Inventors: Kazuhiko Horioka, Kanagawa (JP); Majid Masnavi, Kanagawa (JP); Eiki Hotta, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Tokyo Institute of Technology, Meguro-ku ,Tokyo (JP)

(21) Appl. No.: 11/913,728

(22) PCT Filed: Apr. 28, 2006
(86) PCT No.: PCT/JP2006/308989

§ 371 Date: Jun. 5, 2008

(30) Foreign Application Priority Data
May 6, 2005 (JP) 2005-134796
Jan. 13, 2006 (JP) 2006-005683

(51) Int. Cl. H05B 41/36

(52) U.S. Cl. 315/308

(57) ABSTRACT

A plasma generation apparatus for generating a plasma within a discharge chamber is disclosed, which includes a plurality of electrodes disposed within the discharge chamber, a power supply device operative to flow a discharge current between electrodes for performing self-heating of a plasma between the electrodes and for applying a self-magnetic field to the plasma, and a control unit for control of the power supply device, wherein the control unit controls the power supply device in such a way as to confine the plasma in a space, thereby improving the conversion efficiency of extreme ultraviolet (EUV) light. A plasma generation method is also disclosed.

### TECHNICAL FIELD

The present invention relates generally to plasma generation and, more particularly, to a technique for generating a plasma to emit extreme ultraviolet (EUV) light.

### BACKGROUND ART

Extreme ultraviolet (EUV) light with a wavelength of from 10 nm to 13 nm is expected for use in light sources which are high in industrial utility value, such as a lithography light source of next-generation ultrafine semiconductor integrated circuits. As one of EUV generation techniques, there is known an approach which utilizes the so-called discharge produced plasma (DPP) scheme.

FIG. 1(a) shows an equivalent circuit of one prior known DPP-based plasma generator apparatus. More specifically, the equivalent circuit includes a serial connection of a coil L (circuit inductance) and a capacitor C, with a switch S and a plasma discharging unit Z being connected thereto. An example of the plasma discharger unit Z used here is a narrow, long discharge tube having a diameter of several millimeters, called the capillary (slender tube). Upon start-up of discharging by causing the switch S to turn on (ON) after having charged the capacitor C, a simple current waveform iₚ(t) appears at the discharger unit Z, which waveform is represented by a trigonometric function of angular frequency ω that is proportional to a square root of LC (root LC).

FIG. 1(b) graphically shows a current waveform iₚ(t) during discharging and a discharge voltage Vₚ(t) in the same time scale. Note here that the time t in the lateral axis is 2 μs per 1 div, the discharge current iₚ of the vertical axis is 1.6 kA per 1 div, and the discharge voltage Vₚ of the vertical axis is 5.0 kV per 1 div. In reality, the discharge current iₚ is not completely the trigonometric function and attenuates due to the presence of a resistive component(s).

FIG. 1(c) shows a way of plasma discharging. As shown in FIG. 1(c), upon startup of discharging, a plasma P emits light with a wavelength λ and simultaneously grows into a cylindrical or tubular form with respect to a center axis A of the discharge tube. A plasma radius rₚ and plasma length are affected by a surrounding magnetic field and thus vary with time.

FIG. 2(a) is a diagram graphically showing a relation of plasma electron temperature (eV) (lateral axis) and ion density (cm⁻³) (vertical axis). As apparent from this diagram, in order to obtain an EUV light source based on the plasma discharge, it is generally required to use a plasma of high-temperature/high-density state (EUV radiation condition) as indicated by an ellipse. However, a compressed plasma that is produced by prior known DPP scheme is incapable of holding the high-temperature/high-density state because of the fact that it is cooled down due to expansion within a very short time period. Thus, the energy conversion efficiency (light emission efficiency) was kept extremely low.

FIGS. 2(b) and 2(c) are diagrams for explanation of the principle of magnetic compression, which is a plasma heating method. Usually, in the presence of a DC current iₚ, a magnetic field B_{θ} is created in a circumferential direction (right-hand screw direction) of a straight line segment. As shown in FIG. 2(b), the magnetic field B_{θ} that is created by a plasma current iₚ flowing in the discharge tube decreases in plasma radius rₚ due to the plasma current's own magnetic field and thus behaves to contract (note that a time spanning from the discharge startup to maximal contraction of the plasma is called the maximum contraction time τᵢ). Whereby, the plasma density becomes higher, resulting in rapid rise-up of the plasma temperature. This is called the Z-pinch effect or, simply, pinch effect. Based on this principle, the plasma is compressively confined within the magnetic field, thereby making it possible to realize both the plasma heating and the plasma density enhancement at a time.

Additionally, as a prior art document which teaches the background art of the present invention, there is a paper by the present inventors (M. Masnavi, M. Nakajima, A. Sasaki, E. Hotta, K. Horioka, “Characteristics of Extreme Ultraviolet Radiation Conversion Efficiency of Xenon Plasma,” Jap. J. Appl. Phys., Vol. 43, No. 12 (2004)), which has evaluated the influence of the ionization nonequilibrium affecting the conversion efficiency of a light source plasma.

Also note that the prior art technique employs as media a highly ionized plasma of xenon (Xe) or tin (Sn) whereby multiple radiation spectrum lines exist so that the prior art was low in spectrum efficiency—that is, a ratio of occupation of an effective spectral region in the entire radiation spectrum.

To avoid this problem, attempts have been made to use a plasma of lithium (Li) as the light source media for laser irradiation and discharge emission in view of the fact that such Li plasma is simple in spectral structure and ensures the presence of a strong spectrum line (13.5 nm) in the effective spectrum region.

However, the prior art approach lacks the concept for trying to retain the plasma within an extended length of time period of about microseconds or more, it was a must for the prior art method to utilize a freely expanding laser heating plasma or a short-pulse pinch discharge plasma or else. As a consequence, the retention time of emission plasma was short, and the lithium plasma was almost equal in conversion efficiency to those using the xenon (Xe) or tin (Sn). The method of retaining the plasma by pinch discharge is disclosed in a patent bulletin (WO 2005/025280 A2). The method of lengthening the plasma retention time is found in a non-patent document (Applied Physics Letters, Vol. 87, No. 11, pp. 111502-1 to 111502-4 (2005)).

### DISCLOSURE OF INVENTION

### Problem to be Solved by the Invention

The present inventors have obtained, from both experimentation and computer simulation-assisted plasma analysis, the length of a retention time of a plasma state of high-temperature/high-density state which contributed to emission of EUV light in a plasma generation apparatus of the type using the DPP scheme.

FIG. 3(a) is a streak photograph which shows the behavior of an ordinary pinch plasma along with a time scale. Plasma conditions here are such that the initial pressure is approximately 66.7 Pa (500 mTorr), and a sealed gas is argon (Ar). The diameter of a capillary is 3 mm. The parameter τₛ is the arrival time of an shock wave, and τᵢ is the maximum contraction time.

FIG. 3(b) is a streamline diagram showing calculation results of one-dimensional magneto-hydro-dynamic (1D-MHD) simulation. Its lateral axis indicates the elapsed time t after having started plasma production; the vertical axis indicates the plasma radius rₚ. Note that the time axis is indicated by the same scale as FIG. 3(a). Comparing two results reveals that the heating by means of shock waves and the confinement based on magnetic compression take place substantially at the same time, wherein the EUV light emission time is at about 10 nanoseconds (ns), which is between the shock wave arrival time τₛ and the maximum contraction time τᵢ, or therearound. It can also be seen that the plasma expands thereafter. Additionally, simulation results of a plasma electron temperature and ion temperature as will be described later indicate that the electron temperature and the ion temperature decrease rapidly due to expansion of the plasma.

According to these simulation results, it was made sure that one typical prior art DPP-based plasma generation apparatus (EUV light source) is such that about 1% of electrical power being given thereto makes a contribution to the light emission, with the remaining power all becoming thermal load (heat load). This encourages us to believe that this heat load poses serious problems, such as unwanted ablation of electrodes and structural components, and occurrence of debris (harmful contaminants).

The inventors concluded the above-noted results in a way which follows. In order to output EUV persistently, it is required to perform a process for heating a plasma and a process for magnetically confining the plasma that was set by heating to a high temperature to thereby retain the high-temperature/high-density state thereof. However, in cases where a current waveform of the trigonometric function is used as the plasma drive current as in the prior art, the drive current reaches a peak whereby the magnetic confinement effect becomes relatively smaller with respect to the plasma pressure after having passed the peak even when EUV is output through sufficient heatup of the plasma so that the once heated plasma expands rapidly, resulting in likewise cool-down. For this reason, the light emission failed to continue.

(1) The present invention is in order to obtain a plasma capable of being controlled persistently.

(2) In addition, this invention is in order to generate a plasma capable of effectively performing light emission.

(3) In addition, this invention is to improve the conversion efficiency of extreme ultraviolet (EUV) light.

(4) In addition, the invention is to alleviate the heat load of a plasma generating part.

(5) In addition, the invention is to alleviate the heat load of a reflection optical system by improving the light emission spectrum efficiency.

(6) In addition, the invention is to reduce discharge derivatives (debris).

(7) In addition, the invention is to lower the average power of a driving power supply unit.

### Means for Solving the Problem

A technical concept in accordance with an embodiment of the present invention lines in separating, in terms of time, the process for heating a plasma and the process for retaining the heated plasma state within a fixed length of time period. In particular, the concept lies in active control of a plasma current (as an example, intentional holding or increase of the plasma current at a specific time point) in such a way that the plasma which was heated in the initial heatup process step is retained for a long time at the next step. Thus it is possible to drastically improve the efficiency of energy conversion to EUV with respect to an energy consumed to the plasma to an extent greater than ever before.

In the process of heating the plasma, a magnetic field B_{θ} which is spontaneously created by the plasma current per se is used to heat and compress the plasma by pinch effects; then, in order to retain the compressed plasma for a long time, another current waveform is further given thereto, thereby actively controlling the plasma current.

A plasma generation method in accordance with an embodiment of the present invention comprises a first step of heating a plasma produced within a discharge chamber, and a second step of magnetically confining the plasma that was heated at the first step to thereby retain the heated state of the plasma within a prespecified length of time period, wherein different patterns of current waveforms are given to inside of the discharge chamber.

The first step is principally a step which creates a plasma of high temperature by pinch effects; at this step, set the plasma in a high-temperature/high-density state and then let it change into a state capable of generating EUV light. The second step is the one that maintains the final state of the first step—i.e., the high-temperature/high-density state—by magnetic confinement effect for a fixed length of time. Continuously performing these steps makes it possible to maintain the high-temperature/high-density state within a time period which is much longer than the prior art. As a result, the light emission duration time of EUV is extended to thereby noticeably improve the energy conversion efficiency.

A plasma generation apparatus in accordance with an embodiment of this invention is a plasma generation apparatus for generating a plasma within a discharge chamber, which comprises a plurality of electrodes that are disposed within the discharge chamber, a power supply device for causing a discharge current to flow between electrodes and for performing self-heating of the plasma between the electrodes and also for applying a self-magnetic field to the plasma, and a control unit which controls the plasma state, wherein the plasma's temperature and density are controlled so that each falls within a prespecified range, thereby confining the plasma in a space.

A plasma generation apparatus in accordance with an embodiment of this invention is generally made up of a discharging unit and a power supply circuit for driving the discharge unit, wherein this power supply circuit comprises at least two or more systems of capacitive discharge circuits, which are driven by independent switching elements S1 to Sn.

Note here that this capacitive discharge circuitry refers to a plurality of paths of discharging circuits using a plurality of capacitors. When using this in the plasma generation method in accordance with the embodiment of the present invention, what is done first is to permit a first discharge circuit to give a first discharge current to a discharger unit; thereafter, let a second discharge circuit to add a second discharge current to the first discharge current. In the case of n stages being provided, it is also possible to achieve more accurate driving in such a way that is a confining current is controlled to hold the EUV output.

A plasma generation apparatus in accordance with an embodiment of this invention is generally made up of a discharge unit and a power supply circuit for driving the discharge unit, wherein the power supply circuit includes at least two or more systems of inductive discharge circuits to be driven by independent switching elements S1-Sn.

This inductive discharge circuitry has a magnetic core unit which is disposed around the discharge unit for superposing induction voltages together. When using this in the plasma generation method in accordance with the embodiment of this invention, what is done first is to cause the first discharge circuit to give a discharge current to the discharger unit by addition of a first induction voltage; thereafter, let the second discharge circuit to add a second induction voltage to thereby add a second discharge current to the first discharge current. In the case of n stages being provided, it is also possible to achieve more accurate driving in such a way that the confinement current is controlled to hold the EUV output.

Determination as to whether the current control scheme or the voltage control scheme is employed comes with pros and cons: in any case, it is important to drive the current which permits the heated plasma to be held without change.

A plasma generation apparatus in accordance with an embodiment of this invention is a plasma generation apparatus for generating a plasma within a discharge chamber, which comprises a plurality of electrodes that are disposed within the discharge chamber, a power supply device for driving a discharge current to flow between electrodes and for performing self-heating of the plasma between the electrodes and also for applying a self-magnetic field to the plasma, and a control unit for control of the power supply device, wherein the control unit controls the power supply device to confine the plasma in a space, thereby enhancing the light emission spectrum efficiency of such plasma.

A plasma generation method in accordance with an embodiment of this invention is a plasma generation method for producing a plasma within a discharge chamber, which comprises the steps of flowing a discharge current in the plasma for performing self-heating of the plasma and for giving a self-magnetic field to the plasma, and applying an external magnetic field to the plasma, wherein the discharge current and the external magnetic field are controlled to control the plasma retention time to thereby enhance the emission spectrum efficiency of the plasma.

### BRIEF DESCRIPTION OF DRAWINGS

FIG. 1(a) shows an equivalent circuit of a plasma generation apparatus by means of the prior art DPP scheme. FIG. 1(b) shows a current waveform iₚ and discharge voltage Vₚ during the discharging. FIG. 1(c) shows a way of plasma discharging.

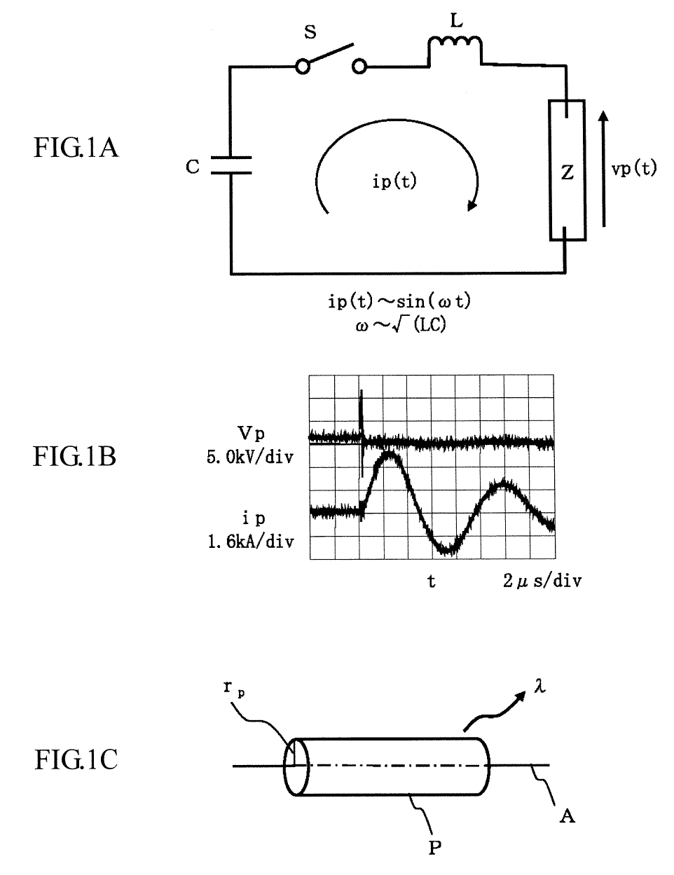

FIG. 2(a) shows a relation of plasma's electron temperature versus ion density. FIGS. 2(b) and 2(c) are for explanation of the principle of magnetic compression which is a plasma heating method.

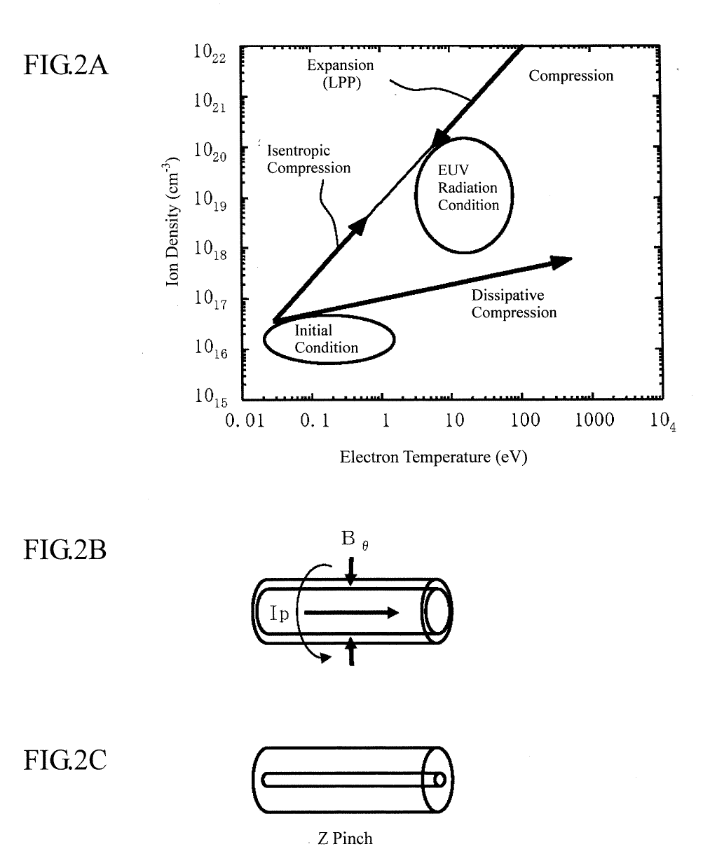

FIG. 3(a) is a streak photograph showing the behavior of an ordinary pinch plasma with indication of a time scale. FIG. 3(b) shows a calculation result of one-dimensional magneto-hydrodynamic (1D-MHD) simulation, wherein the lateral axis indicates the elapsed time after startup of plasma generation whereas the vertical axis indicates the plasma radius rₚ.

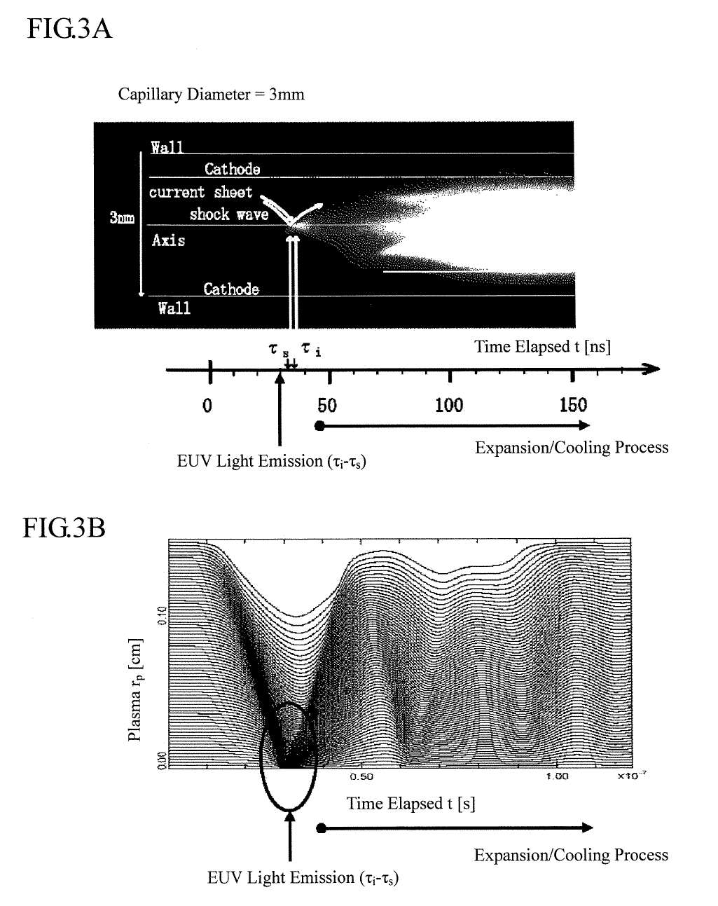

FIG. 4(a) shows a result of MHD simulation of a relation of the elapsed time t after plasma production versus the electron temperature Tₑ based on a collisional relative equilibrium (CRE) model and SESAME model, with an ionic valency value Zᵢ and a streamline diagram being superimposed thereon. FIG. 4(b) shows a result of MHD simulation of a relation of elapsed time t after plasma production versus the ion temperature Tᵢ based on CRE and SESAME models, with an ionic valency value Zᵢ and a streamline diagram being superposed thereover.

FIGS. 5(a) and 5(b) are graphs each showing an elapsed time in lateral axis and a plasma current and EUV's light emission output in vertical axis.

FIG. 6(a) shows a multiple-discharge circuit which includes capacitors which are driven by independent switching elements. FIG. 6(b) shows a circuit which is an extended version of the circuit of FIG. 6(a) in such a way as to have n stages.

FIG. 7 shows an n-stage inductive multi-discharge circuit having magnetic bodies 10.

FIG. 8(a) is a sectional diagram of a structure of main body of a DPP-based plasma generator apparatus in accordance with one embodiment of the present invention, and FIG. 8(b) is a reference photograph as taken from the observation window side of the main body.

FIG. 9 shows a plasma generation apparatus comprising an external magnetic field generator device, an external heating device, and a plasma media feed-use heating device.

FIG. 10 shows a plasma generation apparatus having an oven and a diffuser at an electrode.

FIG. 11 shows a plasma generation apparatus having within an electrode a through-going hole for permitting an energy beam, such as electron beam, to pass therethrough.

FIG. 12(a) shows a spectral radiation intensity distribution of a plasma with an electron density of xenon (Xe) of 10¹⁸/cc. FIG. 12(b) shows a spectral radiation intensity distribution of a plasma with an electron density of xenon (Xe) of 10¹⁹/cc.

FIG. 13(a) shows a spectral radiation intensity distribution of a plasma with an electron density of lithium (Li) of 10¹⁸/cc. FIG. 13(b) shows a spectral radiation intensity distribution of a plasma with an electron density of lithium (Li) of 10¹⁹/cc. FIG. 13(c) shows a spectral radiation intensity distribution of a plasma with an electron density of lithium (Li) of 3×10¹⁹/cc.

FIG. 14 shows a relation of an energy needed for heatup with respect to a plasma temperature of each of xenon (Xe), tin (Sn) and lithium (Li).

FIG. 15(a) shows the efficiency of radiation conversion to an effective region of a lithium plasma with respect to electron temperature and density in a prior art short-pulse plasma. FIG. 15(b) shows the efficiency of radiation conversion to an effective region of a lithium plasma with respect to electron temperature and density in a plasma of this invention which is created by confinement.

### MODES FOR CARRYING OUT THE INVENTION

### Principle of Plasma Generation Apparatus

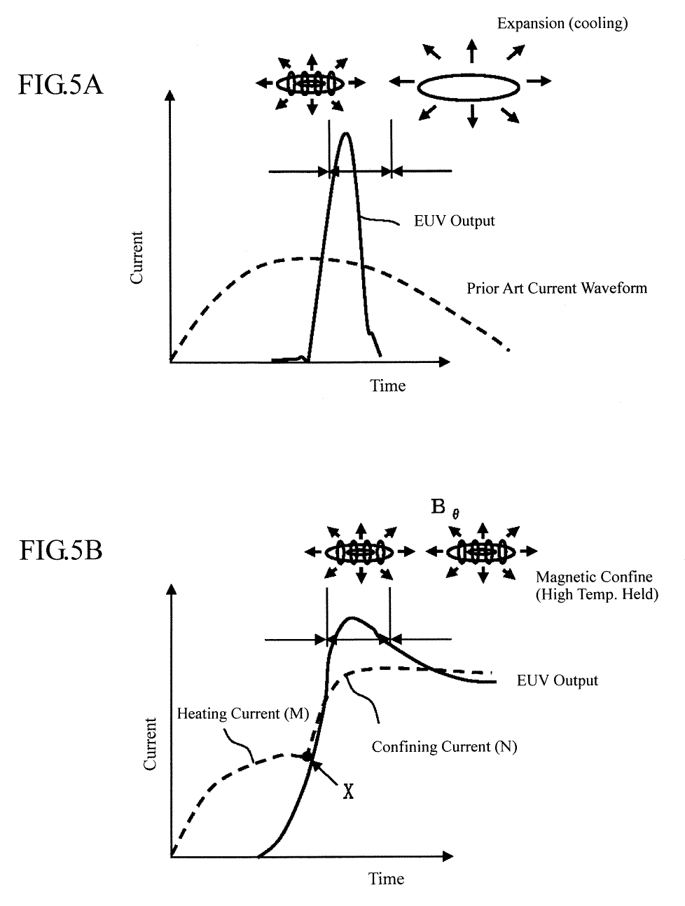

FIGS. 5(a) and 5(b) are diagrams for explanation of the solving principle of the present invention, each of which indicates an elapsed time in lateral axis and a plasma current and EUV light emission output in vertical axis. FIG. 5(a) represents a prior art current waveform by a broken line and indicates its resultant EUV output by a solid line. As shown in FIG. 5(a), the prior art current waveform is a current waveform which is with a trigonometric function being as its basic; thus, upon startup of discharging, the plasma current Iₚ increases with elapse of time. After having passed a peak, it changes to decrease at this time. For this reason, heatup and compression (and its following magnetic confinement) take place with an increase in current value Iₚ. When the plasma temperature goes beyond a prespecified threshold value at or near the peak of the current value, EUV light appears. However, after maximal compression, the magnetic confinement effect becomes relatively smaller with respect to the plasma pressure whereby the plasma expands so that the plasma temperature drops down. As a result, the EUV output also has decreased rapidly.

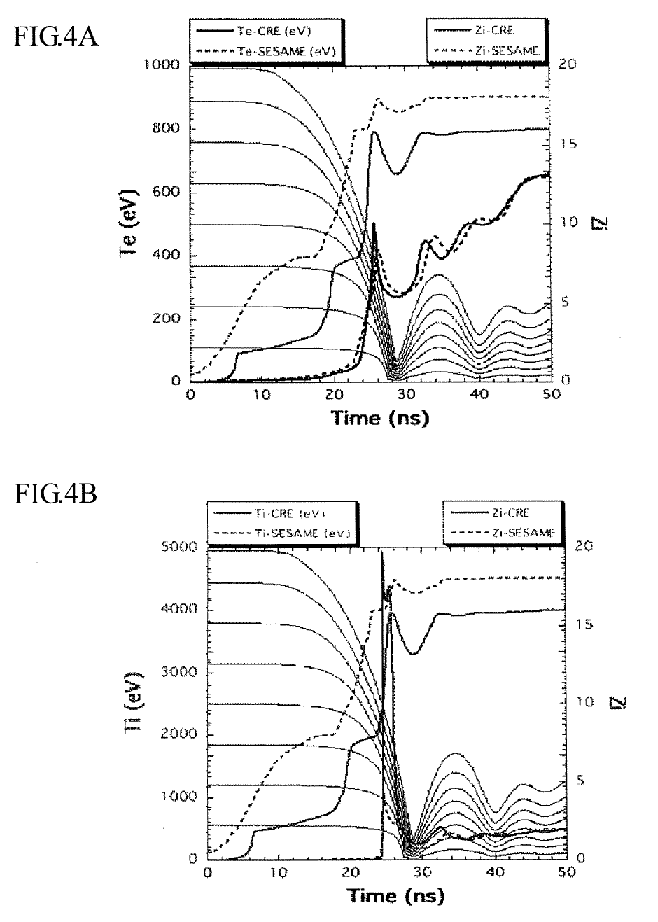

The relation of the plasma density and electron/ion temperature and degree of ionization has not yet been established, and several models have been proposed concerning them. FIG. 4(a) shows a result of MHD simulation of the relation of elapsed time t (ns) after plasma generation versus electron temperature Te (eV) based on CRE collision radiation model and SESAME model (the model based on the U.S. database), with ion valency value Zi and stream-line diagram being superimposed thereon. FIG. 4(b) shows a result of MHD simulation of the relation of elapsed time t (ns) after plasma generation versus ion temperature Ti (eV) based on CRE collision radiation model and SESAME model, with ion valency value Zi and stream-line diagram being superposed thereon. The length of a time period for retaining the EUV output was computed by these reliable simulation results to reveal that the retention time of a high temperature plasma which is effective for the light source was merely 10 ns, or more or less, which is about 1% in efficiency equivalent thereto.

FIG. 5(b) shows the case of actively controlling the plasma current Iₚ in such a way as to prevent reduction of the EUV output. The initial plasma current Iₚ is an electrical current for heating the plasma (heating current) (first process); then, after the EUV output increased, let the current value further increase in order to confine the plasma (second process); next, set the current value at a fixed level to thereby retain this state (third process). In this example, a drive current is designed to have two current waveforms (i.e., the heating current M and confining current N as indicated in the drawing) whereby it was possible to maintain the duration time of the EUV output for 30 ns, at least.

In this way, by actively controlling the current waveform (that is, intentionally increasing or maintaining it at a certain time point) to suppress plasma expansion (i.e., lower the plasma temperature), thereby to retain the EUV output for a long time. Note here that although the current waveform is arrangeable to have various patterns depending upon a configuration of circuitry making up these components, an example is that it is formable with addition of the waveform of heatup current and the waveform of magnetic confinement current.

One prior known plasma generation method includes the steps of producing a plasma within a discharge chamber and heating the plasma while at the same time magnetically confining the heated plasma to thereby retain the heatup state of the plasma for a fixed length of time. This method is performed by using a single pattern of current waveform (trigonometric function waveform), simultaneously and passively. In contrast, a plasma generation method in accordance with one preferred form of this invention is specifically arranged to perform the first step of heating a plasma which was generated within a discharge chamber and the second step of retaining the heatup state of the plasma for a fixed length of time by confining the plasma that was heated at the first step, while letting them be distinctly separated from each other, in a way such that the both steps are performed and actively driven by “more than two different patterns of current waveforms.” Additionally, a decision as to whether the current waveform is of a single pattern or more than two different patterns is readily made by checking whether a fold/bend point “x” is present in the current waveform pattern in close proximity to the maximum shrinkage or contraction.

### (Plasma Generation Apparatus)

A plasma generation apparatus is the one that generates a plasma and retains the state of such plasma. In particular, the plasma generation apparatus embodying the invention is for enhancing the radiation efficiency of a spectrum emitted from the plasma—especially, for retaining the plasma state in the best possible optimum state to thereby enhance the radiation efficiency in a specific waveform region. The radiation property of the spectrum from the plasma is a function of plasma density and temperature. In view of this, the plasma temperature and density plus a magnetic field are controlled for adjustment of the plasma retention time to retain the plasma in a quasi-steady state to thereby enhance the radiation efficiency. The plasma generation apparatus may be applied to a light emission device which enhances the radiation efficiency of the spectrum emitted from a plasma—in particular, applicable to a light source which emits extreme ultraviolet (EUV) light at high efficiency.

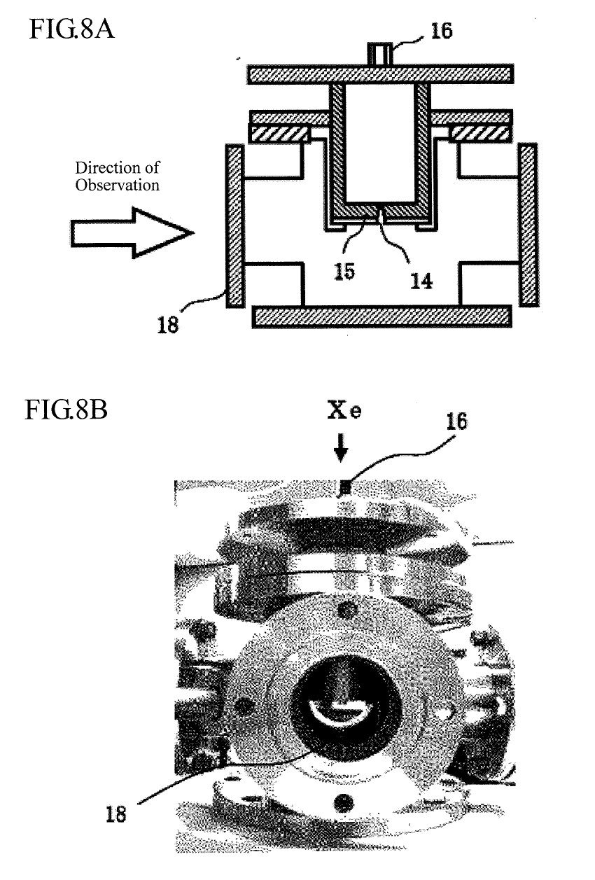

FIG. 8(a) shows a sectional view of a structure of main body of a plasma generation apparatus of the type using the DPP scheme in accordance with one embodiment of the present invention, and FIG. 8(b) is a photograph which was shot from the observation window side. A discharge unit is a capillary (fine tube) 14 having a diameter of 3 mm and a length of about 10 cm, which is structured to introduce a xenon (Xe) gas through a gas inlet port 16 that is provided at upper part. Electrodes are disposed above and below the capillary (fine tube) 14, with a dielectric material 15 being disposed between the electrodes. The xenon (Xe) gas is guided to pass through the capillary 14 from the upper part and then flow downward. The inside condition is visually observable from an observation window 18. The electrodes of this main part are connected to a discharging circuit to be later described.

### (Capacitive Multi-Discharge Circuit of Power Supply Device)

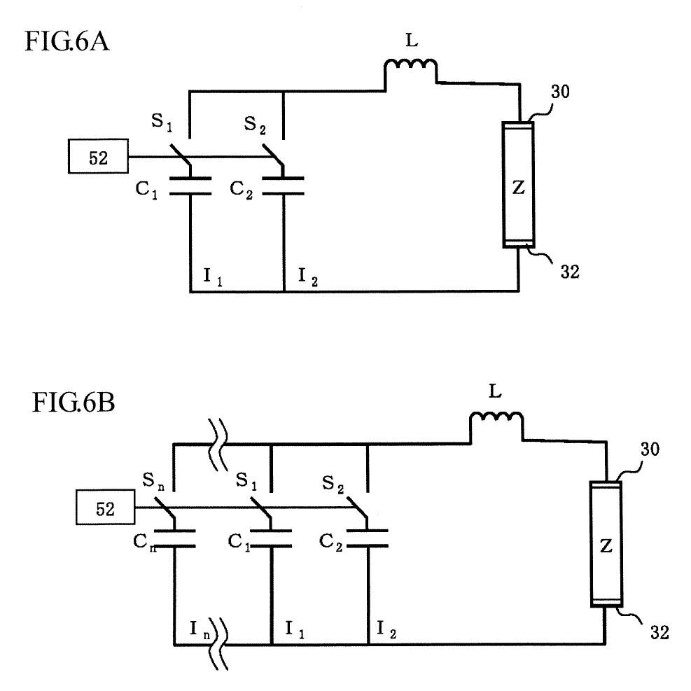

FIG. 6(a) shows schematically a capacitive multi-discharge circuit of a power supply device. In FIG. 6(a) capacitors are driven by independent switching elements S1, S2. Examples of the switching elements S are magnetic switches, semiconductor switches (such as thyristors or else), and discharging switches (thyratrons or else). In a discharge unit (plasma light source unit) Z, a first electrode 30 and second electrode 32 are disposed. Upon initiation of discharging from a first capacitor C1 by causing the first switch to turn on, a first discharge current I₁ flows into the discharge unit (plasma light source unit) Z through a coil L plus the first electrode 30 and second electrode 32. The current I₁ flowing in the discharge unit (plasma light source unit) Z is used to heat the plasma. Then, when turning the second switch S1 on, the current flowing in the discharge unit Z is such that a discharge current I₂ from the second capacitor C2 is added to the current I₁. This is for use as a confinement current for retaining by magnetic confinement the plasma in a high-temperature/high-density state. Of course, the two-stage circuit configuration is modifiable to have n stages as shown in FIG. 6(b), for performing more precise current control. Switching elements S₁, S₂, . . . , Sn are switching-controlled by a control unit 52. With this control, it is possible to form any given waveform.

### (Inductive Multi-Discharge Circuit of Power Supply Device)

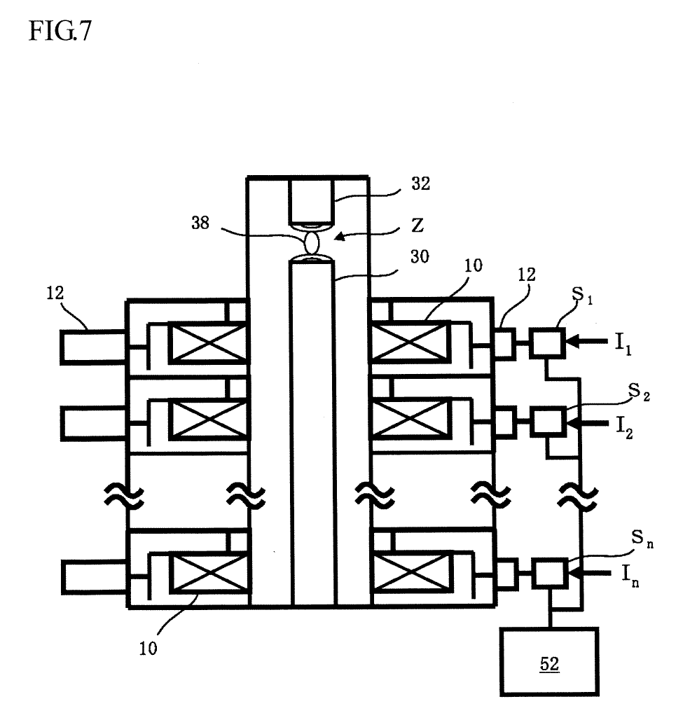

FIG. 7 shows schematically an inductive n-stage multi-discharge circuit of power supply device. In the case of FIG. 7, a primary side coil's electrode 12 and a secondary side coil's electrodes 30-32 are disposed with respect to magnetic bodies 10. A voltage is applied to the primary side coil electrode 12 through a switching element S. When applying the voltage to the primary side coil electrode 12 by causing the switching element S to turn on, the voltage is induced at a discharge unit Z which is between the first electrode 30 and second electrode 32 of the secondary side coil. In the case of FIG. 7, n magnetic bodies 10, 10 . . . are disposed around the first electrode 30 on the secondary side. When performing turn-on/off control of switching elements S₁, S₂, . . . , Sn by the control unit 52, secondary voltages are generated at those magnetic bodies which correspond to the turned-on switching elements S, followed by superposition of these secondary voltages, resulting in an added or “synthesized” voltage being induced at the discharge unit Z that is between the first electrode 30 and second electrode 32 of the secondary side coil. More specifically, by letting a current I₁ flow into the first primary side coil, apply the induced voltage between the first electrode 30 and second electrode 32 to thereby flow a current in a plasma 38. This current is for heating the plasma 38. Next, by causing a current I₂ to flow into the second primary side coil, apply the induced voltage between the first electrode 30 and second electrode 32 to thereby flow a current in the plasma 38. Whereby, the current I₂ due to the second induced voltage is added to the current I₁ due to the first induced voltage. The resultant added current is for use as a confinement current for confining the plasma of the high-temperature/high-density state. The two-stage induced voltage may be replaced by an n-stage induced voltage being applied between the first electrode 30 and second electrode 32, when the need arises. The position of the discharge unit Z may be set at any given location as far as it is guaranteed that the secondary voltage is induced at the discharge unit Z and then a current flows in the plasma 38. The switching elements S₁, S₂, . . . , Sn are controlled by the control unit 52 for enabling formation of any given waveform.

As a result of execution of numerical computation using magneto-hydrodynamic models with atomic processes being taken into consideration, each revealed that the energy conversion efficiency obtained increases by a factor of at least three or greater when compared to a current waveform such as the simple triangle function in the prior art.

### (Plasma Generation Apparatus for Changing Environmental Conditions by External Device)

Plasma generation apparatus operates to flow a discharge current in electrodes which interpose a plasma therebetween, form a magnetic field by the discharge current, causes the magnetic field to act on the plasma, and heat the plasma by the discharge current. This magnetic field which was created by the discharge current of the plasma is called the self-magnetic field. The heating of the plasma to be generated by the discharge current is called the self-heating. The plasma generation apparatus is equipped with an external magnetic field generation device which adds a magnetic field to the plasma. The plasma generation apparatus confines the plasma by the self-magnetic field and further by an externally applied magnetic field, thereby to control the plasma's density and temperature along with the magnetic fields. The plasma generation apparatus performs self-heating by the discharge current and, when the heating is inadequate, controls the plasma temperature by external heating. For this purpose, the plasma generation apparatus has an external heating device which heats the plasma from the outside whenever the need arises. In this way, the plasma generation apparatus controls the plasma's magnetic field and temperature for confining the plasma to retain the plasma at a predetermined temperature and density, thereby enhancing the radiation efficiency of light emission spectrum from the plasma. Examples of a plasma medium are any available materials which become a plasma, including but not limited to xenon (Xe), tin (Sn), and lithium (Li). An explanation below assumes that a lithium media is used as an example. In the case of the lithium being used as the plasma media, the plasma generation apparatus produces a strong spectral line in an effective band (wavelength region) which contains a lithium spectrum of 13.5 nm. An electron temperature of the plasma in this state is preferably set to range from 5 eV to 30 eV whereas an electron density of such plasma is preferably held to range from 10¹⁷ cm⁻³ to 10²⁰ cm⁻³. It is noted here that the wavelength region containing the 13.5 nm lithium spectrum is a wavelength range which is less in absorption even for reflection and that a light source of this wavelength region is effectively adaptable for use in exposure/lithography apparatus and inspection equipment or like tools. Preferably, this wavelength region is a range of ±1% with 13.5 nm being as a reference level.

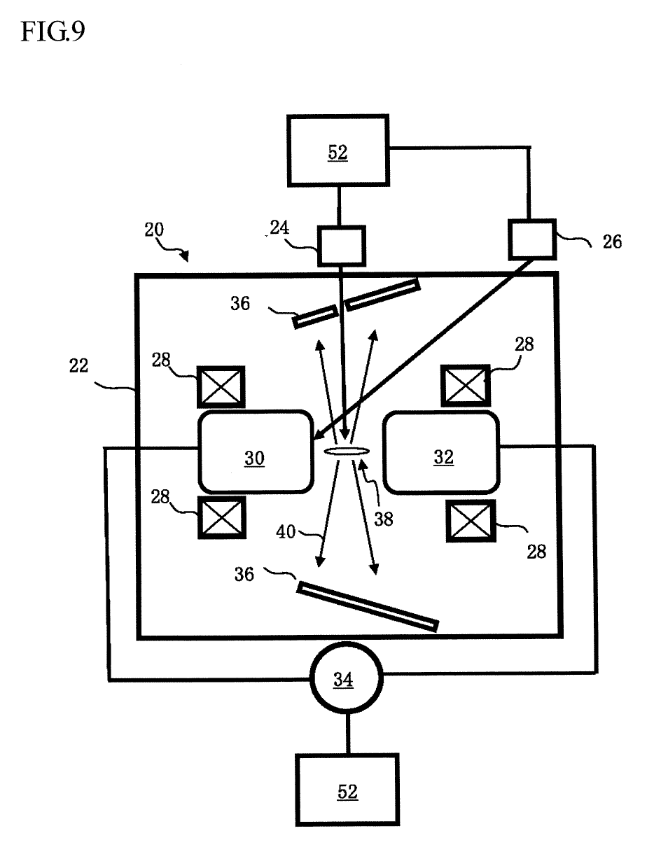

FIG. 9 shows one example of a configuration of the plasma generation apparatus. The plasma generation apparatus 20 has a discharge chamber 22 which shields its interior space from the outside. The plasma generation apparatus 20 is arranged so that a first electrode 30 and second electrode 32 are disposed within the discharge chamber 22 for producing a plasma 38 between the first electrode 30 and second electrode 32. The plasma generation apparatus 20 also includes a power supply device 34 for applying a voltage between the first electrode 30 and second electrode 32 to permit a controlled discharge current to flow between the first electrode 30 and second electrode 32. The flow of a discharge current creates a self-magnetic field and applies a confinement magnetic field to the plasma 38 and, at the same time, heats the plasma 38. The plasma generation apparatus 20 comprises an external magnetic field generator device 28 for giving an external magnetic field to the plasma 38. A coil for use as the external magnetic field generator device 28 is designed, for example, to have a cylindrical or tubular shape which surrounds the circumference of the columnar first electrode 30 and the circumference of the columnar second electrode 32, wherein the plasma 38 is created along the axis of such cylinder. The plasma generation apparatus 20 also comprises an external heating device 24, if necessary, which heats the plasma 38. The plasma generation apparatus 20 includes a plasma media feed-use heating device 26, which supplies an operation gas from an electrode to the plasma 38. The plasma generation apparatus 20 also includes a light collecting/focusing unit 36, which collects together light rays as given off from the plasma 38, in accordance with specific use applications such as exposure apparatus or pattern inspection equipment or the like. In a light path of the light collection unit 26 et seq., a pattern-formed photomask and its underlying photoresist are disposed, by way of example. Light emitted from the plasma 38 forms the pattern of the photomask on the photoresist. An example of the light collector unit 36 is a light reflection plate or else. The power supply device 34, the external magnetic field generator device 28 and the external heating device 24 are under control of the control unit in various ways.

The discharge chamber 22 is a vessel which can form a vacuum in its interior space in such a way as to permit the first electrode 30 and second electrode 32 to perform discharging therebetween while ensuring that light emitted from the plasma 38, such as EUV 40, arrives at the light collection unit 36 without appreciable absorption. The first electrode 30 and second electrode 32 may be those electrodes capable of flowing the discharge current. In case these electrodes are made of the same element as that of plasma media, it is possible to supply the plasma media from more than one of the electrodes. For instance, in the case where the electrodes are made of a lithium metal and the plasma media is of lithium, it is possible by irradiating a laser beam or electron beam onto the lithium electrode to produce a lithium gas from the electrode in a pulsed fashion. In this case, the plasma media feed-use heating device 26 may be a device capable of irradiating an energy, such as a laser beam or electron ray, onto the electrode. The external magnetic field generator device 28 may be the one that can give a magnetic field to the plasma 38. An example of it is a coil which is disposed around the electrode. If this is the case, an external magnetic field to be created by this coil is superposed with the self-magnetic field, causing this superposed magnetic field to act on the plasma. In the case of FIG. 9, the external magnetic field and the self-magnetic field are at right angles to each other, and the resulting combined strong magnetic field is expected to act on the plasma. The external heating device 24 may be any available device as far as it has an ability to externally heat the plasma. An example thereof is a device capable of heating the plasma 38 by irradiation of an energy beam, such as a laser beam, to the plasma 38. The light collection unit 36 is disposed at an appropriate location capable of collecting the EUV 40 to be produced by the plasma 38. In case the plasma generation apparatus 20 is used as an exposure apparatus, a material which is an exposure object is disposed in a light path at a post-stage of the light collection unit 36.

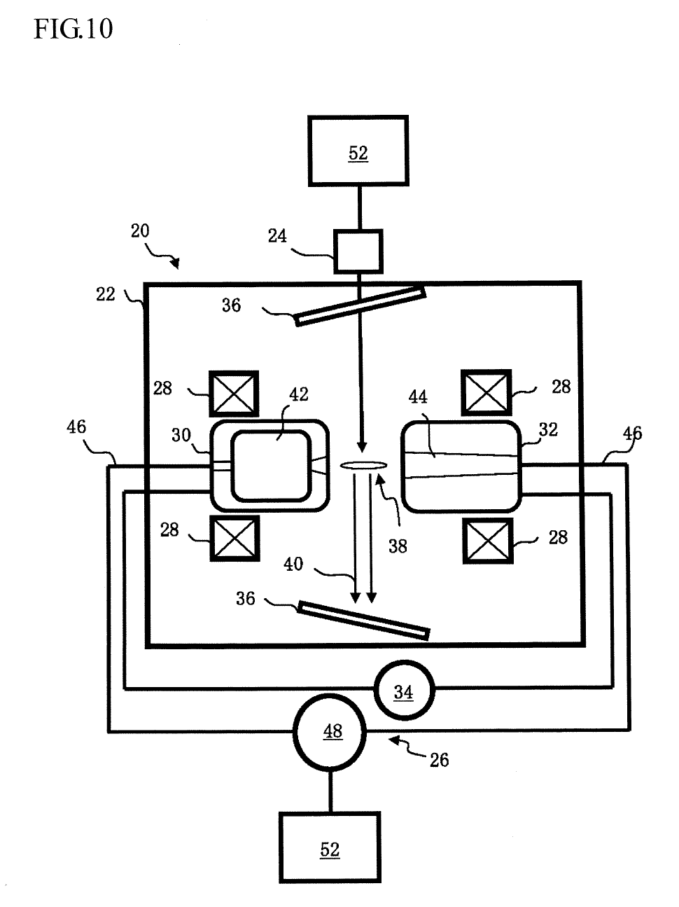

FIG. 10 shows another exemplary configuration of the plasma generation apparatus 20. The plasma generation apparatus 20 of FIG. 10 is principally different from the plasma generation apparatus 20 of FIG. 9 in an arrangement for supplying the plasma 30. A plasma media feed-use heating device 26 of FIG. 10 is generally made up of an oven 42, a diffuser 44, pipes 46, and a circulation device 48. The oven 42 is formable within the first electrode 30. A gas for use as the plasma media which is exhausted from the oven 42 is supplied into the plasma 38. The diffuser 44 is formed within the second electrode 32 for recovery and collection of a plasma gas from the plasma 38. The plasma gas recovered is then collected in the circulator device 48 via one of the pipes 46. Additionally the plasma gas is supplied by the circulator 48 through pipe 46 into oven 42. This oven 42 is capable of heating the plasma media and also applying a pressure thereto.

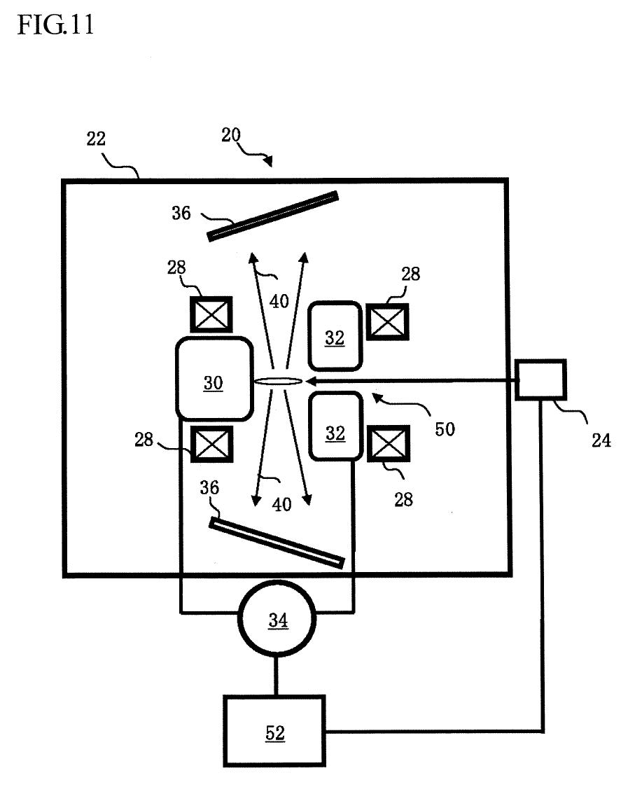

FIG. 11 shows still another exemplary configuration of the plasma generation apparatus 20. The plasma generation apparatus 20 of FIG. 11 is mainly different from the plasma generation apparatuses 20 of FIGS. 9 and 10 in configuration of the second electrode 32 and in arrangement for supplying the plasma media. A second electrode 32 of the plasma generation apparatus 20 of FIG. 11 has therein a through-going hole 50. The external heating device 24 irradiates either an electron beam or a laser beam onto the electrode 30 and plasma 38 via the through-hole 50 to thereby supply the plasma media and, at the same time, heat the plasma 38. The second electrode 32 and the coil of external magnetic field generator device 28 are formed to have a cylindrical shape, causing a plasma to be created along the axis of such cylinder.

### (Plasma Generation Method)

A method for generating a plasma will be explained while taking as an example the plasma using the power supply device of FIG. 6 or 7. Firstly, let the first discharge current I₁ in a plasma of discharge unit Z for heating the plasma; simultaneously, perform the first step of magnetically confining the plasma and the second step of superposing second discharge current I₂ that is different from the first discharge current I₁ to thereby enable control of the retention time of the plasma. The two-stage design may be replaced by n-stage design. This permits application of a more complicated current waveform(s) to the plasma, thereby making it possible to perform the plasma control with high precision.

Another plasma generation method will be explained while taking as an example the lithium plasma using the plasma generation apparatus 20 of FIG. 9. Under control of the control unit 52, the power supply device 34 applies a voltage between the first electrode 30 and second electrode 32 for performing current control to thereby perform discharging between the first electrode 30 and second electrode 32. When using a lithium metal for the electrodes, the discharging results in production of a lithium vapor from the electrodes, causing a lithium plasma to be created. The lithium plasma between the first electrode 30 and second electrode 32 is heated by the discharge current and, at the same time, confined by a self-magnetic field due to such discharge current. The external magnetic field generator device 28 flows a current in the coil for creation of an external magnetic field, and then applies a magnetic field to the plasma from the outside for confining the plasma together with the self-magnetic field to thereby stably retain the density of the plasma 38 so that it stays within a predefined range. In case the plasma temperature is inadequate, the plasma 38 is additionally heated by the external heating device 24. Preferable conditions are as follows: the electron temperature of plasma 38 is set to fall within a range of 5 eV to 30 eV; the electron density of plasma 38 is set to range from 10¹⁷ cm⁻³ to 10²⁰ cm⁻³. In particular, the electron temperature is preferably set to range from 10 eV to 20 eV whereas the electron density ranges from 10¹⁷ cm⁻³ to 10¹⁹ cm⁻³. With hold-up of these conditions, the plasma 38 becomes an EUV light source in effective band, resulting EUV being emitted from the plasma 38. This EUV is irradiated to the light collection unit 36 and is used for various applications. The current to be driven between the first electrode 30 and second electrode 32 is desirably a DC current, although it is replaceable by a pulse current. A control method of this power supply device 34 employs a current control technique. In cases where the plasma media feed-use heating device 26 is used as lithium vapor addition/generation methods, a radiation, such as an electron beam or laser beam, is irradiated by the plasma media feed-use heating device 26 onto the first electrode 30 made of lithium, which is used as a negative electrode to generate a lithium vapor from the lithium first electrode 30.

An explanation will be given of a plasma generation method using the plasma generation apparatus 20 of FIG. 10. A lithium vapor is supplied between the first electrode 30 and second electrode 32 from the oven 42 which is installed within a lithium cathode of first electrode 30. Let it discharge between the first electrode 30 and anode of second electrode 32 by use of the power supply device 34 that has a current control ability. A plasma between the electrodes is heated by a discharge current and, simultaneously, trapped by a self-magnetic field due to the flow of an electrical current. The plasma is confined by use of an external magnetic field in addition to the self-magnetic field, thereby retaining a constant plasma condition and stability. In order to maintain the constant plasma condition, control the current. Light usage is possible mainly in a sideface direction from the light source plasma which is arranged so that the electron temperature is held at 10 eV to 20 eV whereas the electron density is at 10¹⁷ cm⁻³ to 10¹⁹ cm⁻¹. The lithium is collected for recovery by the diffuser 44 of the anode, and is then forced to circulate by using the circulator device 48.

An explanation will be given of a plasma generation method using the plasma generation apparatus 20 of FIG. 11. A lithium vapor is supplied mainly by self-heating from the lithium metal cathode 30. If the lithium gas is deficient, the heating device 24 is used as an auxiliary heater; if the lithium gas is excessive, the electrode cooling is done to reduce the supply amount thereof. Control the power supply device 34 to permit discharging between the cathode 30 and anode 32. A plasma between these electrodes is heated by a discharge current and, at the same time, confined by a self-magnetic field due to the current flow. An external magnetic field is created by the external magnetic field generator device 28 in addition to the self-magnetic field for confining the plasma 38; further, the heating device 24 is used to maintain the fixed plasma condition, when the need arises.

### (Plasma Efficiency of Lithium Plasma)

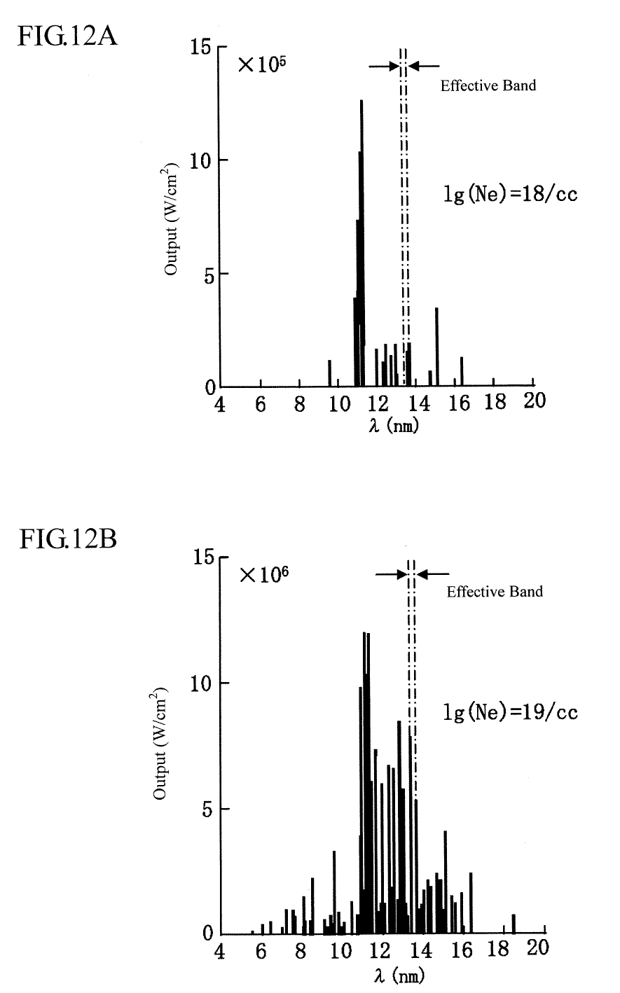

FIG. 12 shows typical radiation intensity distributions of the spectrum of a xenon (Xe) plasma when the plasma radius is set at 400 μm, wherein the lateral axis is a waveform λ (nm), and vertical axis is output intensity (W/cm²). FIG. 12(A) shows a spectrum of EUV in the case of the electron density of xenon in a plasma state being set to 10¹⁸/cc. FIG. 12(B) shows a spectrum of EUV in the case of the electron density of xenon in a plasma state being set to 10¹⁹/cc. In this way, it is shown that the xenon in the plasma state is extremely low in ratio of spectrum strength in an effective region near the waveform of 13.5 nm and is irradiating the spectrum intensity which is strong in a region of waveforms shorter than the effective region.

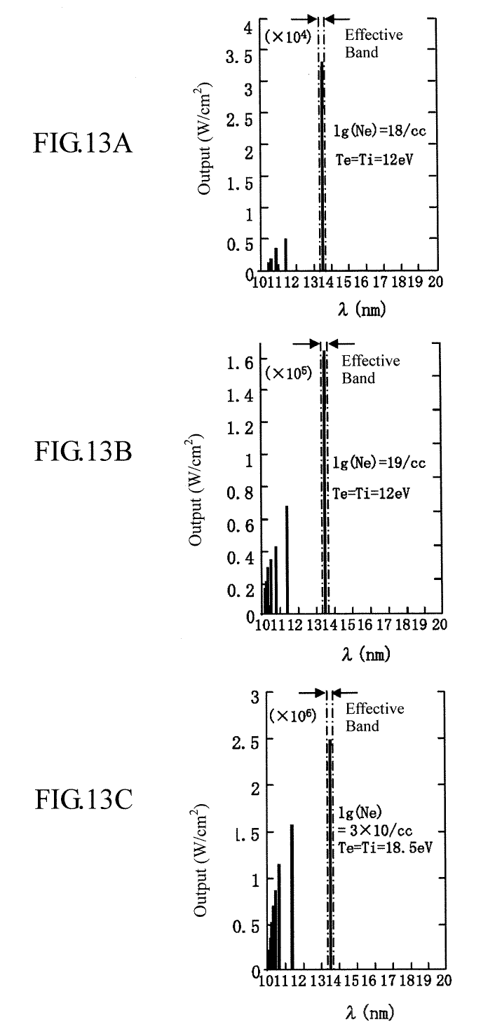

FIG. 13 shows typical radiation intensity distributions of the spectrum of a lithium (Li) when the plasma radius is set at 400 μm, wherein the lateral axis is the waveform λ (nm) whereas the vertical axis is the output intensity (W/cm²). FIGS. 13(A), 13(B) and 13(C) are such that vertical axis units are 10⁴, 10⁵ and 10⁶, respectively, whereas electron density values of the lithium in a plasma state are 10¹⁸/cc, 10¹⁹/cc and 3×10¹⁹/cc, respectively. Additionally, FIGS. 13(A), 13(B) and 13(C) indicate that the plasma electron temperature Te and the ion temperature Ti are equal to each other and also show the states of 12 eV, 12 eV and 18.5 eV, respectively. In this manner, in the radiation strength distributions of the lithium Li in the plasma state, the wavelength of 13.5 nm of the effective region appears strongly in any one of the conditions.

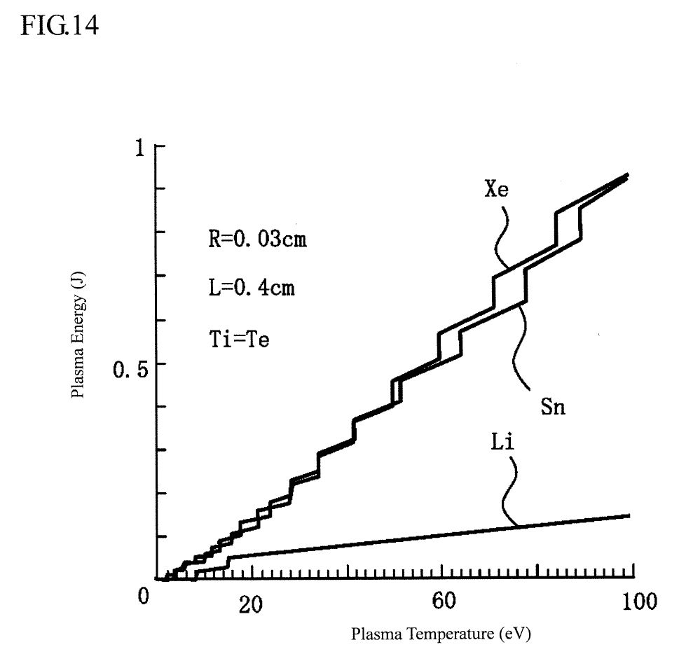

FIG. 14 shows a relation of plasma temperature and plasma energy in regard to plasma media of xenon (Xe), tin (Sn) and lithium (Li), wherein the lateral axis indicates the plasma temperature (eV) whereas vertical axis indicates the plasma energy (joule J). The plasma's ion density is 10¹⁸/cc in any gas. The plasma's radius R is 300 μm (0.03 cm) and its length is 0.4 cm, thus indicating a state that the electron temperature Ti and the ion temperature Te are equal to each other. Note here that the plasma energy is a sum of thermal energies (electrons and ions) and an ionization potential. This graph shows that the xenon (Xe) and tin (Sn) are such that a plasma energy necessary for the heating rises up rapidly with an increase in plasma temperature whereas the lithium (Li) is such that the energy hardly increases. This in turn indicates that the lithium (Li) is less than the xenon (Xe) and tin (Sn) in electric power consumption during plasma creation. This shows that the lithium plasma is high in latent ability for use as a high-efficiency light source plasma.

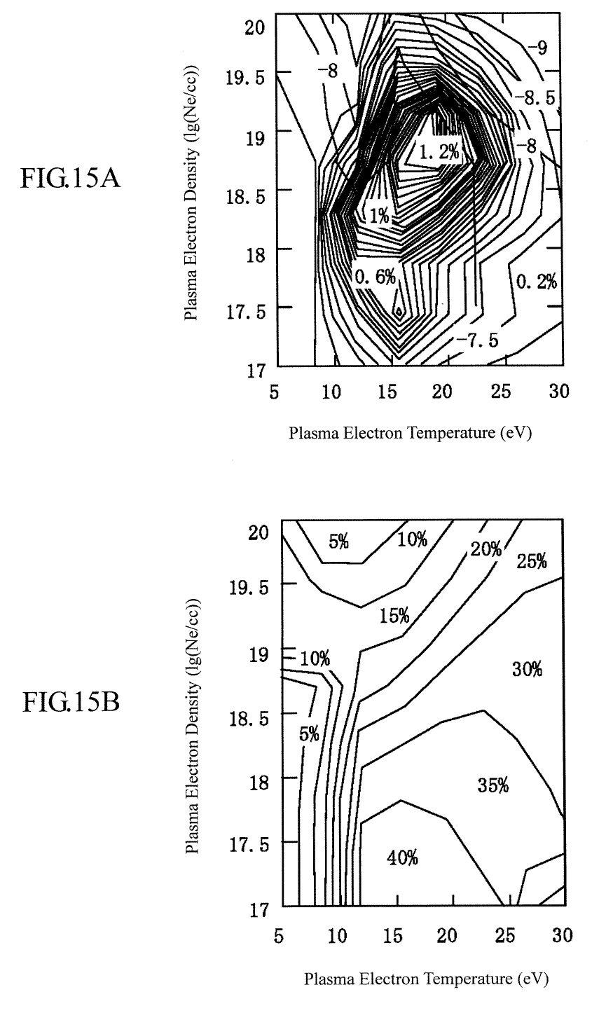

FIG. 15 shows that the conversion efficiency of a lithium plasma exhibits strong dependency on a confinement time period. The lateral axis is a plasma electron temperature (eV) whereas vertical axis is plasma electron density (logarithmic scale 1 g (Ne/cc)), showing level curve graphs of plasma efficiency CEp (%/2πsr). FIG. 15(A) shows a graph of plasma efficiency in the case where the retention time of plasma is a short time. Lines crossing counter lines of the graph of FIG. 15(A) with numerals “−7.5,” “−8,” and “−9” inserted therein are plasma retention times which are represented logarithmically—more precisely, these indicate pulse widths of 10^{-7.5} sec., 10⁻⁸ sec., and 10⁻⁹ sec., respectively. The graph of FIG. 15(A) indicates limit lines of the efficiency that is determinable by such pulse width. In prior art techniques, a plasma which is retainable only in the form of short pulses is used; thus, what is expected is merely the efficiency in the upper right region of the limit line. The plasma efficiency CEp is about 1.2 (%/2πsr) in maximum at points whereat the temperature is about 20 eV and the electron density is 10¹⁹/cc, or more or less.

By contrast, FIG. 15(B) shows the plasma efficiency CEp in the case where the plasma retention time is secured sufficiently. In this case, the plasma efficiency reduces to the spectrum efficiency. In FIG. 15(B), contour lines of the spectrum efficiency CEp are drawn, wherein the plasma efficiency is as high as 45 (%/2πsr) when the plasma electron temperature is about 10 eV to 25 eV, and the plasma electron density is less than or equal to 10¹⁸/cc. In case the plasma generation apparatus is used as exposure or lithography equipment, it is needed to produce a large amount of photons. To increase the light amount, it is preferable that the plasma density be high in the above-noted parameter region; however, the plasma efficiency becomes higher as the density becomes lower. The density and temperature of the plasma to be retained may be selected depending on which one of the output or the efficiency is thought more importantly. Preferably the plasma temperature is about 5 eV to 30 eV and the plasma density is about 10¹⁷/cc to 10²⁰/cc. Under such conditions, the plasma density is relatively large and the plasma efficiency is relatively high; thus, it is possible to obtain an increased amount of light. Regarding the apparatus, it is desirable that the plasma efficiency and the density and temperature be set at lower values. More preferably, the plasma electron temperature is set to range from 10 eV to 20 eV.

### (Calculation Ground of Plasma Efficiency of Lithium Plasma)

FIG. 15(B) is obtained in a way which follows. The conversion efficiency CE of an effective waveform (13.5 nm±1% is indicated by λb 2%) in the light emitted from a plasma is obtainable by Equation (1) below. Its denominator indicates an input energy to the plasma, and the numerator denotes a radiation energy in effective waveform region. In Equation (1), M_{λ} is the integrated spectral radiation intensity, Sₚ is the surface area of radiation plasma, τ is the radiation time, and E is the energy to be consumed for heating and ionization of the plasma.

[EQU1]

$$CE ( in 4 π sr ) = \frac{\sum {M}_{λ 2 \%} {S}_{p} τ}{\sum {M}_{λ} {S}_{p} τ + E} \qquad ( 1 )$$

In Equation (1), if the radiation time τ can be made longer sufficiently, E of the denominator is negligible, resulting in the radiation time τ and radiation plasma's surface area Sₚ being cancelled. Accordingly, the conversion efficiency CE at this time reduces to the spectrum efficiency ηₛ of Equation (2) below.

[EQU2]

$${η}_{s} = \frac{\sum {M}_{λ 2 \%}}{\sum {M}_{λ}} \qquad ( 2 )$$

Equation 2 is the characteristics in the case of DC such as shown in FIG. 15(B), which is entirely different from the prior art transient characteristics shown in FIG. 15(A). Traditionally, the efficiency has been studied only under transient conditions capable of retaining a plasma by mere use of short pulses, so the spectrum efficiency per se has not been studied deeply. In the transient case, each of the lines (numerals of −9, −7.9) crossing the contour lines of the graph of plasma efficiency indicates the limit of efficiency which is determined by the pulse width that is logarithmically represented. In the plasma that is retained merely in a short pulse fashion, what can be expected is only the efficiency in the upper right region of the limit line.

The present invention is capable of obtaining the light source of high light-emission spectrum efficiency of FIG. 15(B) by retaining the plasma state in the form of long pulses, including a direct current. A result of detailed consideration of the conversion efficiency as a function of the radiative plasma retention time has revealed the facts which follow: it is possible to improve the radiation efficiency of an effective band by controlling plasma parameters, such as plasma temperature, plasma density, radius, etc., through adjustment of the magnitude of an electric current and/or the intensity of a magnetic field; and, an indication or standard of the time period in which the confinement effect works well for the improvement of the radiation efficiency is about 10⁻⁶ seconds in the case of a lithium plasma. To do this, apply an external magnetic field to the plasma in addition to the self-heating and the self-magnetic field due to a discharge between electrodes, and also give thereto external heatup when the need arises. Performing these operations makes it possible to achieve a balance of the confinement force and the incoming and outgoing energies, which in turn enables stable control of the plasma parameters for an extended length of time beyond the retention time required.

### INDUSTRIAL APPLICABILITY

The plasma generation apparatus and method in accordance with the embodiments of this invention are easy in implementation as the apparatus and method can be reduced to practice through a mere change of power supply drive circuit part of prior known plasma generation apparatus and offers an ability to dramatically increase the energy conversion efficiency when compared to the prior art to thereby suppress wastage of electrodes or structural components or suppress unwanted production of debris.

1. A light source for generating a plasma within a discharge chamber and for producing extreme ultraviolet light from the plasma, comprising:
a plurality of electrodes disposed within the discharge chamber;
a power supply device capable of actively controlling an amount of an electrical current flowing between electrodes, for performing self-heating of a plasma between the electrodes and for giving a self-magnetic field to the plasma; and
a control unit for controlling the power supply device, wherein
said control unit actively controls the power supply device for changing in amount the current flowing between the electrodes to control a temperature and a density of the plasma in such a way as to retain a plasma state suitable for radiation of extreme ultraviolet light of a specific waveform region within a time period of microseconds or more, thereby enhancing radiation efficiency of said extreme ultraviolet light.

2. (canceled)

3. The light source for producing extreme ultraviolet light from the plasma according to claim 1, wherein the power supply device has a plurality of paths of discharge circuits to be driven by a switching element, and wherein the control unit controls the switching element for driving each discharge circuit.

4. The light source for producing extreme ultraviolet light from the plasma according to 3, wherein the discharge circuits are either capacitive discharge circuits or inductive discharge circuits.

5. The light source for producing extreme ultraviolet light from the plasma according to claim 1, further comprising:
an external magnetic field generation device for giving an external magnetic field to the plasma; and
said control unit controlling the external magnetic field generation device to change the magnetic field being given to the plasma.

6. The light source for producing extreme ultraviolet light from the plasma according to claim 5, further comprising:
a temperature control device for externally controlling a temperature of the plasma; and
said control unit controlling the external magnetic field generation device and the temperature control device to thereby change the magnetic field being given to the plasma and a plasma temperature.

7. The light source for producing extreme ultraviolet light from the plasma according to claim 1, wherein a plasma medium is a lithium.

8. (canceled)

9. The light source for producing extreme ultraviolet light from the plasma according to claim 7, further comprising:
an external magnetic field generation device for giving an external magnetic field to the plasma; and
said control unit controlling the external magnetic field generation device to thereby change the magnetic field being given to the plasma.

10. The light source for producing extreme ultraviolet light from the plasma according to claim 7, wherein an electrode for flowing a discharge current is made of a lithium metal and wherein a plasma medium of lithium is supplied from the lithium metal to inside of the discharge chamber.

11. The light source for producing extreme ultraviolet light from the plasma according to claim 7, wherein a lithium plasma is 5 eV to 30 eV in electron temperature and is 10¹⁷ cm⁻³ to 10²⁰ cm⁻³ in electron density.

12. (canceled)

13. (canceled)
